(19) United States
(12) Patent Application Publication
(10) Pub. No.: US 2026/0153460 A1
(43) Pub. Date: Jun. 4, 2026

(54) NEUTRON DIFFRACTION STRESS MEASUREMENT DEVICE AND METHOD BASED ON SPATIAL COORDINATE MEASUREMENT

(71) Applicant: Shanghai Jiao Tong University, Shanghai (CN)

(72) Inventors: Shengyi ZHONG, Shanghai (CN); Hao LIN, Shanghai (CN); Pucong SHENG, Shanghai (CN); Junjie YANG, Shanghai (CN); Haoyu ZHAI, Shanghai (CN); Jiachen LONG, Shanghai (CN)

(73) Assignee: Shanghai Jiao Tong University, Shanghai (CN)

(21) Appl. No.: 19/461,544

(22) Filed: Jan. 27, 2026

(30) Foreign Application Priority Data
Oct. 10, 2025 (CN) 202511438627.X

(51) Int. Cl. G01N 23/207; G01N 23/20008

(52) U.S. Cl. CPC G01N 23/2073; G01N 23/20008; G01N 2223/106; G01N 2223/303; G01N 2223/32

(57) ABSTRACT

Disclosed are a neutron diffraction stress measurement device and method based on spatial coordinate measurement, including: an autonomous navigation vehicle, an attitude adjustment system, a spatial measurement sensor, a neutron detector, a sample stage, and a main controller. The attitude adjustment system is fixedly mounted on the autonomous navigation vehicle, with the neutron detector detachably mounted thereon. The autonomous navigation vehicle moves the neutron detector to a vicinity of a designated position. The spatial measurement sensor measures an actual position and attitude of the neutron detector and sends measurement data to the main controller. The main controller sends a motion command, executes coordinate transformation and inverse kinematics operations, and outputs a control signal. Thus, accurate positioning of the neutron detector is realized, and a neutron diffraction stress measurement is completed.

### FIELD

The present disclosure relates to the technical field of neutron diffraction stress measurement, and specifically, relates to a neutron diffraction stress measurement device and method based on spatial coordinate measurement.

### BACKGROUND

Neutron diffraction stress measurement technology is a key means for non-destructive testing of internal stress of materials, and is widely applied in fields such as mechanical manufacturing, aerospace, and nuclear energy equipment. Residual stress or working stress of a material can be obtained by inversion by analyzing diffraction characteristics of a neutron beam, which is crucial for evaluating safety and process rationality of a component.

Existing neutron diffraction stress measurement devices mostly adopt a “fixed turntable+linkage mechanism” architecture, in which a neutron detector is fixed on a fixed turntable, and a position thereof is adjusted through linkage transmission. However, there are obvious technical defects. First, error accumulation is serious. Superposition of errors in multiple links, such as manufacturing deviation of the fixed turntable, machining error of the linkage, and assembly gap, leads to insufficient positioning accuracy of the neutron detector, making it difficult to meet high-precision measurement requirements. Second, movement flexibility is poor. A rigid constraint of the linkage limits a motion trajectory of the neutron detector, making it impossible to adapt to measurement of a large-size sample. Moreover, a rotation angle around the sample is limited, which easily forms a measurement blind spot. Third, an attitude adjustment ability is weak. Only coarse adjustment with 2-3 degrees of freedom can be realized, and clamping deviation of the sample cannot be finely compensated or a specific diffraction angle cannot be matched, thereby affecting signal receiving efficiency.

The above defects restrict measurement accuracy and expansion of application scenarios, making it difficult to meet requirements for complex samples and high-precision detection. Therefore, it is urgent to improve the device architecture to break through a technical bottleneck.

### SUMMARY

In view of defects in the prior art, provided in the present disclosure are a neutron diffraction stress measurement device and method based on spatial coordinate measurement.

According to a neutron diffraction stress measurement device based on spatial coordinate measurement provided in the present disclosure, the neutron diffraction stress measurement device includes: an autonomous navigation vehicle, an attitude adjustment system, a spatial measurement sensor, a neutron detector, a sample stage, and a main controller.

The attitude adjustment system is fixedly mounted on the autonomous navigation vehicle. The neutron detector is detachably mounted on the attitude adjustment system. The autonomous navigation vehicle is used for carrying the neutron detector and the attitude adjustment system to move to a vicinity of a designated position in a measurement space.

The spatial measurement sensor is used for measuring an actual position and attitude of the neutron detector in the measurement space, and sending measurement data to the main controller.

The main controller is electrically connected to the autonomous navigation vehicle, the attitude adjustment system, and the spatial measurement sensor, respectively, and is used for sending a motion command, receiving the measurement data, executing a coordinate transformation operation and an inverse kinematics operation, and outputting a control signal.

The sample stage is disposed within a measurement range of the neutron detector, and is used for supporting a sample to be measured and adjusting a position and attitude of the sample to be measured.

In some embodiments, the attitude adjustment system is a precision six-degree-of-freedom parallel mechanism, and is used for adjusting a six-degree-of-freedom position and attitude of the neutron detector, so as to compensate for a motion error of the autonomous navigation vehicle.

In some embodiments, the spatial measurement sensor is a laser tracker or a machine vision sensor, and is used for outputting a three-dimensional position and attitude data of the neutron detector in the measurement space.

In some embodiments, the neutron diffraction stress measurement device further includes a sensor motion mechanism. The sensor motion mechanism is connected to the spatial measurement sensor, and is used for driving the spatial measurement sensor to adjust a spatial position.

In some embodiments, the neutron diffraction stress measurement device further includes a detector controller. The detector controller is electrically connected to the neutron detector, and is used for controlling a working state of the neutron detector and recording the measurement data.

The detector controller receives an instruction from the main controller, controls the neutron detector to enable/disable a neutron diffraction measurement, and records neutron diffraction data obtained by measurement in real time and feeds the neutron diffraction data back to the main controller.

According to a neutron diffraction stress measurement method based on spatial coordinate measurement provided in the present disclosure, the neutron diffraction stress measurement method includes the following steps:

Step S1: The main controller acquires a target measurement position of the neutron detector, and sends a motion command to the autonomous navigation vehicle; and the autonomous navigation vehicle carries the neutron detector and the attitude adjustment system to move to a vicinity of the target measurement position according to the motion command.

Step S2: The main controller synchronously sends an adjustment command to the sensor motion mechanism, and the sensor motion mechanism drives the spatial measurement sensor to move to a measurement station corresponding to the target measurement position.

Step S3: The spatial measurement sensor performs position and attitude measurement on the neutron detector, and sends raw data obtained by measurement to the main controller.

Step S4: The main controller executes a coordinate transformation operation on the raw data, and converts the raw data into actual position and attitude data of the neutron detector under a spectrometer working coordinate system.

Step S5: The main controller calculates a deviation vector between the target measurement position and an actual position and attitude, and executes an inverse kinematics operation according to the deviation vector to obtain a joint space compensation amount used for compensating for a position and attitude error.

Step S6: The main controller sends a control signal to the attitude adjustment system according to the joint space compensation amount, and the attitude adjustment system drives the neutron detector to move to complete position and attitude error compensation.

Step S7: If the actual position and attitude of the neutron detector meet a measurement requirement, the main controller sends a measurement command to the detector controller, and the detector controller controls the neutron detector to enable a measurement function to complete neutron diffraction stress measurement of a current station, and records the measurement data.

In some embodiments, the inverse kinematics operation in Step S5 is a motion control algorithm for the attitude adjustment system, and is used for calculating a displacement amount required by each axis of the precision six-degree-of-freedom parallel mechanism in a joint space according to the deviation vector, so as to realize precise compensation of six degrees of freedom of the neutron detector.

In some embodiments, a measurement accuracy of the spatial measurement sensor in Step S3 is not lower than 0.1 mm, and the spatial measurement sensor outputs three-dimensional coordinate and attitude angle data of the neutron detector in real time.

In some embodiments, a method for adjusting a position of the spatial measurement sensor by the sensor motion mechanism in Step S2 includes:
taking an unobstructed state and measurement path linearity as adjustment targets, ensuring that no obstacle exists between the spatial measurement sensor and the neutron detector to interfere with a measurement signal.

Compared with the prior art, the present disclosure has the following beneficial effects:

1. In the present disclosure, the position and attitude of the neutron detector in space are directly measured by the spatial measurement sensor. This solves the problem of indirect measurement of a spectrometer structure of a turntable and a linkage of a traditional neutron diffraction stress spectrometer, avoids accumulation of multiple errors such as a manufacturing error, an assembly error, and a motion error, and improves system accuracy.

2. In the present disclosure, the neutron detector is transported by the autonomous navigation vehicle. The neutron detector can move to a desired position in the measurement space, is not constrained by a detector stage and a linkage, and can automatically adjust a distance between the neutron detector and the sample stage. A rotation angle of the neutron detector around the sample stage is larger, and is not limited by a mechanical structure of the linkage.

3. In the present disclosure, the position and attitude of the neutron detector in six degrees of freedom in space can be precisely adjusted by the attitude adjustment system. A traditional neutron diffraction stress spectrometer is fixed and cannot be adjusted in multiple degree-of-freedom directions, and completely relies on installation accuracy and motion accuracy of the turntable.

### BRIEF DESCRIPTION OF THE DRAWINGS

Other features, objectives, and advantages of the present disclosure will become more apparent by reading the detailed description of non-limiting embodiments with reference to the following drawings:

FIG. 1 is a schematic diagram of structure of a neutron diffraction stress measurement device based on spatial coordinate measurement in the present disclosure.

FIG. 2 is a flowchart of a neutron diffraction stress measurement method based on spatial coordinate measurement in the present disclosure.

### DESCRIPTION OF REFERENCE NUMERALS

| | |
|---|---|
| Autonomous navigation vehicle 1 | Spatial measurement sensor 4 |
| Attitude adjustment system 2 | Sample stage 5 |
| Neutron detector 3 | Sample 6 |

### DETAILED DESCRIPTION

The present disclosure is described in detail below in combination with specific embodiments. The following embodiments will help those skilled in the art to further understand the present disclosure, but do not limit the present disclosure in any form. It should be pointed out that for those of ordinary skill in the art, several changes and improvements may also be made without departing from the concept of the present disclosure. These all belong to the protection scope of the present disclosure.

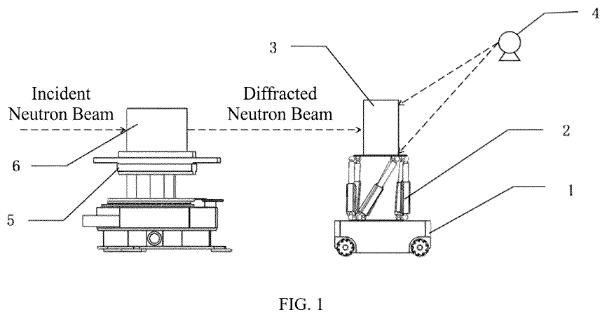

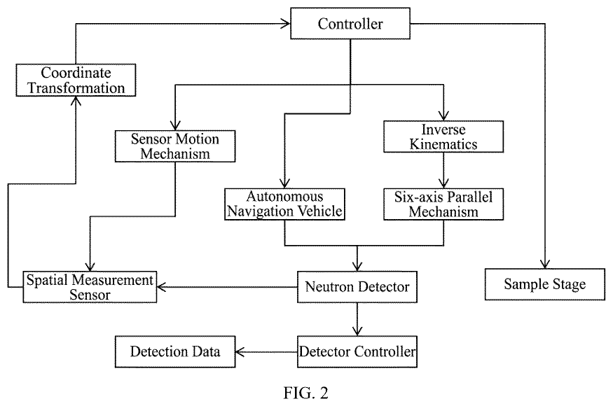

Disclosed in the present disclosure are a neutron diffraction stress measurement device and method based on spatial coordinate measurement. Referring to FIG. 1 and FIG. 2, through a combination of an autonomous navigation vehicle 1, an attitude adjustment system 2, and a spatial measurement system, accurate positioning of a neutron detector 3 in a neutron measurement space is realized, and a neutron diffraction stress measurement task is completed.

The neutron diffraction stress measurement device based on spatial coordinate measurement includes: the autonomous navigation vehicle 1, the attitude adjustment system 2, a spatial measurement sensor 4, the neutron detector 3, a sample stage 5, and a main controller.

The spatial measurement sensor 4 has a function of performing precision coordinate measurement in a large spatial range, may be used for measuring an actual position and attitude of the neutron detector 3 in the measurement space, is used for determining whether the neutron detector 3 arrives at a designated position, and also provides adjustment data for a subsequent adjustment mechanism. A spatial detector may be implemented by using different spatial measurement sensors 4 such as a laser tracker and machine vision.

After the main controller obtains data measured by the spatial measurement sensor 4, the actual position and attitude of the neutron detector 3 under a spectrometer working coordinate system are acquired through coordinate transformation. The coordinate transformation is a conversion algorithm of spatial coordinates, and is used for converting a result obtained by measurement of the attitude adjustment system 2 into the actual position and attitude of the neutron detector 3 under the spectrometer working coordinate system.

The attitude adjustment system 2 is mounted on the autonomous navigation vehicle 1, and the neutron detector 3 is mounted on the attitude adjustment system 2. The autonomous navigation vehicle 1 may carry the neutron detector 3 to arrive at an arbitrary position in the measurement space. The attitude adjustment system 2 may finely adjust the position and attitude of the neutron detector 3 in a smaller area, and compensate for a motion error of the autonomous navigation vehicle 1.

The attitude adjustment system 2 may adopt a precision six-degree-of-freedom parallel mechanism to realize six-degree-of-freedom precision positioning within a local range. Inverse kinematics is a motion control algorithm of the six-degree-of-freedom parallel mechanism, and is used for calculating a displacement amount required by each axis of the parallel mechanism in a joint space according to a target position of the neutron detector 3.

A sensor motion mechanism is used for changing a position of the spatial measurement sensor 4. Since a measurement site environment is relatively complex, the position of the spatial measurement sensor 4 is usually changed to avoid occlusion.

The sample stage 5 is used for supporting a sample 6 to be measured, and adjusting a position and attitude of the sample 6.

The neutron detector 3 is used for measuring a diffracted neutron beam. A detector controller is used for controlling work of the neutron detector 3 and recording measurement data.

The main controller controls the entire neutron diffraction stress measurement process.

The measurement method of the neutron diffraction stress measurement device based on spatial coordinate measurement is further described in detail below:

The neutron diffraction stress measurement method based on spatial coordinate measurement includes:

Step S1: After the main controller acquires a target measurement position of the neutron detector 3, a motion command is sent to the autonomous navigation vehicle 1, and the autonomous navigation vehicle 1 moves to a vicinity of a designated position according to the command.

Step S2: The main controller sends a command to control the sensor motion mechanism to move the spatial measurement sensor 4 to a spatial measurement position corresponding to the target measurement position of the neutron detector 3.

Step S3: The spatial measurement sensor 4 performs measurement on the neutron detector 3, and sends data to the main controller.

Step S4: After the main controller obtains data measured by the spatial measurement sensor 4, the actual position and attitude of the neutron detector 3 under the spectrometer working coordinate system are acquired through coordinate transformation.

Step S5: The main controller calculates a deviation vector between the target position and the actual position of the neutron detector 3. The main controller calculates an inverse kinematics solution of the six-degree-of-freedom parallel mechanism according to the deviation vector, and acquires a joint space compensation amount of the six-degree-of-freedom parallel mechanism used for compensating for a position and attitude error of the neutron detector 3.

Step S6: The main controller controls the six-degree-of-freedom parallel mechanism to move according to the compensation amount, and completes position and attitude error compensation of the neutron detector 3.

Step S7: After the position of the neutron detector 3 meets a measurement requirement, a measurement function may be enabled through the detector controller, neutron measurement of a current step is completed, and measurement data is recorded through the detector controller.

In the description of the present disclosure, it should be understood that orientations or positional relationships indicated by terms such as “upper”, “lower”, “front”, “rear”, “left”, “right”, “vertical”, “horizontal”, “top”, “bottom”, “inner”, and “outer” are based on orientations or positional relationships shown in the drawings. This is only for facilitating description of the present disclosure and simplifying description, rather than indicating or implying that the referred device or element must have a specific orientation or be constructed and operated in a specific orientation, and thus cannot be understood as a limitation on the present disclosure.

The specific embodiments of the present disclosure are described above. It should be understood that the present disclosure is not limited to the above specific embodiments, and those skilled in the art may make various changes or modifications within the scope of the claims, which does not affect the substance of the present disclosure. In a case of no conflict, the embodiments in the present disclosure and features in the embodiments may be combined with each other arbitrarily.

1. A neutron diffraction stress measurement device based on spatial coordinate measurement, comprising:
an autonomous navigation vehicle 1;
an attitude adjustment system 2;
a spatial measurement sensor 4;
a neutron detector 3;
a sample stage 5; and
a main controller;
wherein the attitude adjustment system 2 is fixedly mounted on the autonomous navigation vehicle 1, the neutron detector 3 is detachably mounted on the attitude adjustment system 2, and the autonomous navigation vehicle 1 is configured to carry the neutron detector 3 and the attitude adjustment system 2 to move to a vicinity of a designated position in a measurement space;
wherein the spatial measurement sensor 4 is configured to measure an actual position and attitude of the neutron detector 3 in the measurement space, and transmit measurement data to the main controller;
wherein the main controller is electrically connected to the autonomous navigation vehicle 1, the attitude adjustment system 2, and the spatial measurement sensor 4, respectively, and is configured to send a motion command, receive the measurement data, execute a coordinate transformation operation and an inverse kinematics operation, and output a control signal; and
wherein the sample stage 5 is disposed within a measurement range of the neutron detector 3, and is configured to support a sample 6 to be measured and adjust a position and attitude of the sample 6.

2. The neutron diffraction stress measurement device based on spatial coordinate measurement according to claim 1, wherein the attitude adjustment system 2 is a precision six-degree-of-freedom parallel mechanism configured to adjust a six-degree-of-freedom position and attitude of the neutron detector 3 to compensate for a motion error of the autonomous navigation vehicle 1.

3. The neutron diffraction stress measurement device based on spatial coordinate measurement according to claim 1, wherein the spatial measurement sensor 4 is a laser tracker or a machine vision sensor configured to output a three-dimensional position and attitude data of the neutron detector 3 in the measurement space.

4. The neutron diffraction stress measurement device based on spatial coordinate measurement according to claim 2, further comprising a sensor motion mechanism, wherein the sensor motion mechanism is connected to the spatial measurement sensor 4 and configured to drive the spatial measurement sensor 4 to adjust a spatial position.

5. The neutron diffraction stress measurement device based on spatial coordinate measurement according to claim 4, further comprising a detector controller, wherein the detector controller is electrically connected to the neutron detector 3 and configured to control a working state of the neutron detector 3 and record measurement data; and
wherein the detector controller receives an instruction from the main controller, controls the neutron detector 3 to enable or disable a diffraction neutron beam measurement function, and records neutron diffraction data obtained by measurement in real time and feeds the neutron diffraction data back to the main controller.

6. A neutron diffraction stress measurement method based on spatial coordinate measurement, applied to the neutron diffraction stress measurement device based on spatial coordinate measurement according to claim 5, the method comprising the following steps:
Step S1: acquiring, by the main controller, a target measurement position of the neutron detector 3, and sending a motion command to the autonomous navigation vehicle 1, wherein the autonomous navigation vehicle 1 carries the neutron detector 3 and the attitude adjustment system 2 to move to a vicinity of the target measurement position according to the command;
Step S2: sending, by the main controller, an adjustment command to the sensor motion mechanism synchronously, wherein the sensor motion mechanism drives the spatial measurement sensor 4 to move to a measurement station corresponding to the target measurement position;
Step S3: performing, by the spatial measurement sensor 4, position and attitude measurement on the neutron detector 3, and sending raw data obtained by measurement to the main controller;
Step S4: executing, by the main controller, a coordinate transformation operation on the raw data, and converting the raw data into actual position and attitude data of the neutron detector 3 under a spectrometer working coordinate system;
Step S5: calculating, by the main controller, a deviation vector between the target measurement position and an actual position and attitude, and executing an inverse kinematics operation according to the deviation vector to obtain a joint space compensation amount used for compensating for a position and attitude error;
Step S6: sending, by the main controller, a control signal to the attitude adjustment system 2 according to the joint space compensation amount, wherein the attitude adjustment system 2 drives the neutron detector 3 to move to complete position and attitude error compensation; and
Step S7: if the actual position and attitude of the neutron detector 3 meet a measurement requirement, sending, by the main controller, a measurement command to the detector controller, wherein the detector controller controls the neutron detector 3 to enable a measurement function to complete neutron diffraction stress measurement of a current station, and records measurement data.

7. The neutron diffraction stress measurement method based on spatial coordinate measurement according to claim 6, wherein the inverse kinematics operation in Step S5 is a motion control algorithm for the attitude adjustment system 2, used for calculating a displacement amount required by each axis of the precision six-degree-of-freedom parallel mechanism in a joint space according to the deviation vector, to realize precise compensation of six degrees of freedom of the neutron detector 3.

8. The neutron diffraction stress measurement method based on spatial coordinate measurement according to claim 6, wherein a measurement accuracy of the spatial measurement sensor 4 in Step S3 is not lower than 0.1 mm, and the spatial measurement sensor 4 outputs three-dimensional coordinate and attitude angle data of the neutron detector 3 in real time.

9. The neutron diffraction stress measurement method based on spatial coordinate measurement according to claim 6, wherein a method for adjusting a position of the spatial measurement sensor 4 by the sensor motion mechanism in Step S2 comprises:
taking an unobstructed state and measurement path linearity as adjustment targets, ensuring that no obstacle exists between the spatial measurement sensor 4 and the neutron detector 3 to interfere with a measurement signal.
